(19) United States
(12) Patent Application Publication
(10) Pub. No.: US 2018/0116204 A1
(43) Pub. Date: May 3, 2018

(54) HUNTING ARM SLEEVE

(71) Applicant: Ricky Gravely, Fayetteville, NC (US)

(72) Inventor: Ricky Gravely, Fayetteville, NC (US)

(21) Appl. No.: 15/340,316

(22) Filed: Nov. 1, 2016

(51) Int. Cl. A01M 31/00; A41D 13/00; A41D 13/08; A45F 5/00

(52) U.S. Cl. CPC A01M 31/00; A41D 13/0012; A45F 2005/008; A45F 5/00; A41D 13/08

(57) ABSTRACT

An hunting arm sleeve as hunting accessory includes: a first opening; a second opening; and a plurality of receptacles on an outer surface between the first opening and the second opening, wherein each receptacle is adapted to receive an animal call. The first opening is preferably a first size and the second opening is preferably a second size. Preferably, the plurality of receptacles may include four receptacles.

### BACKGROUND OF THE INVENTION

### Field of Invention

The present invention relates to an hunting arm sleeve for hunting accessories.

### Description of Related Art

Hunters use various equipment to participate in the sport of hunting. Particularly related to various techniques used to attract and/or hunt animals. Hunters may use a scent as one means to attract animals, hunters also attempt to track animals and another manner to attract animals is through the use various whistles or calls in a form of whistles that mimic animal sounds. In terms of animal calls a hunter may use more than one call depending on the type of game that they are pursuing. As a result, several calls may be implemented and carried by the hunter. However, it may be cumbersome to maneuver through different calls without creating various distracting sounds that may alert the prey to flee. As a result, it would be advantageous to have a device that could be used to store animal calls while a hunter is hunting.

### SUMMARY OF THE INVENTION

The present invention relates to a hunting arm sleeve as hunting accessory includes: a first opening; a second opening; and a plurality of receptacles on an outer surface between the first opening and the second opening, wherein each receptacle is adapted to receive an animal call. The first opening is preferably a first size and the second opening is preferably a second size. Preferably, the plurality of receptacles may include four receptacles.

### BRIEF DESCRIPTION OF DRAWINGS

FIG. 1 depicts a hunting arm sleeve in accordance with the present invention.

### DETAILED DESCRIPTION

The present invention relates to a hunting arm sleeve use as a hunting accessory. The hunting arm sleeve includes two openings that allow for the sleeve to be placed over the arm of a user. Receptacles are placed on an outer surface of the hunting arm sleeve that allow for the placement of animal calls by a user. In this manner the animal calls may be quickly retrieved and then stored for later use by a hunter.

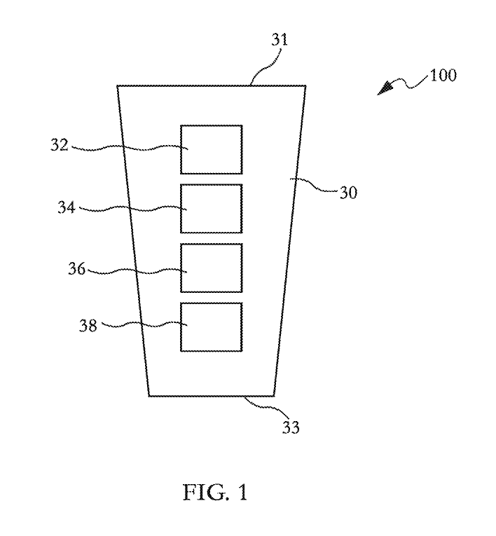

In reference to FIG. 1, a hunting arm sleeve 100 in accordance with the present invention is depicted. The hunting arm sleeve 100 is shown with a first opening 31 and a second opening 33. The first opening 31 is preferably larger than the second opening 33. The second opening 33 fits close to the wrist of a user and the first opening 31 slides upward on the forearm. This configuration allows for a secure fit over the forearm of a user. Along the outside surface of the sleeve 100 is a series of receptacles 32, 34, 36, 38. These receptacles 32, 34, 36, 38 are developed for to receive an animal call. The animal call may be slid into each one of the receptacles and held in place while a hunter is wearing the sleeve 100. Although four receptacles are depicted in FIG. 1, any multiple of receptacles may be placed on the outer surface of the sleeve 100. The hunting arm sleeve 100 further serves as an arm protector, which is very useful with respect to a bow hunter. But most advantageously the sleeve 100 provides quick access to various animal calls that may be used by a hunter.

1. A hunting arm sleeve as hunting accessory comprising:
a. a first opening at a first end, where the first opening is a first size;
b. a second opening at a second end, where the second opening is a second size, wherein the first size is smaller than the second size so as the first opening fits near a user's wrist and the second opening fits near a user's forearm; and
c. a plurality of receptacles on an outer surface, where the plurality of receptacles are aligned perpendicular between the first opening and the second opening, wherein each receptacle is adapted to receive an animal call.

2. (canceled)

3. The hunting arm sleeve according to claim 1, where the plurality of receptacles includes four receptacles.
